(19) United States
(12) Patent Application Publication
(10) Pub. No.: US 2005/0102431 A1
(43) Pub. Date: May 12, 2005

(54) Composite adapter for multiple peripheral functionality in portable computing system environments

(76) Inventors: Alexandros Markos Maniatopoulos, Patras (GR); Vassilis Constantinos Maniotis, Patras (GR); Constantinos Christos Kontogiannis, Patras (GR); Spyridon Constantinos Kapotas, Patras (GR)

Correspondence Address: SAWYER LAW GROUP LLP, P O BOX 51418, PALO ALTO, CA, 94303, US

(21) Appl. No.: 10/981,350

(22) Filed: Nov. 3, 2004

(30) Foreign Application Priority Data
Nov. 6, 2003 (GR) 20030100453

(51) Int. Cl. G06F 15/16

(52) U.S. Cl. 709/250

(57) ABSTRACT

Aspects for achieving efficient, multiple peripheral functionality in portable computing system environments are described. The aspects include a composite adapter for performing networking and data storage functionality and capable of interfacing with a computing system via a single interface port. The composite adapter includes an embedded system, a medium dependent physical layer unit, and a data storage unit. The embedded system further includes a single integrated circuit for substantially simultaneously handling and servicing the networking and data storage functionality.

### FIELD OF THE INVENTION

The present invention relates to generally to portable peripherals of computing systems with multifunction capabilities, and more particularly to a composite adapter for substantially simultaneous networking and data storage functionality.

### BACKGROUND OF THE INVENTION

In portable computing systems, normally a minimal number of ports for communicating with external peripherals is available. The minimal number is even more restrictive in hand held devices due to their size and weight limitations. Thus, attempts to integrate new technology into such systems face delays and difficulties due to the size limitations of the systems, as well as costs incurred for specialized applications and peripherals.

For example, the wireless LAN or WiFi technology offers wireless networking not only to laptop or desktop computing systems but also to many hand held devices. With the evolution of the wireless technology, advances are continual with regard to the available bandwidth offered to the user and to the advanced protocols for security and quality of services. Often, new generations of products are available that provide these advances even before the devices implementing the “old” protocols are able to be upgraded.

In some cases, therefore, system upgrade is done by using an external adapter that can be readily integrated via one of the available interface standards today, each of which tends to have plug and play (PnP) capabilities, like Universal Serial Bus (USB), PCI, Card Bus, PCMCIA and SDIO, to support devices with multiple functions/multiple interfaces.

While multifunction peripherals that combine specific applications on an adapter requiring a single interface port further aid in addressing the limitations of these systems, of particular need is an adapter that combines two of the most common periphery tasks of a computing system: networking and data storage in a small form factor portable adapter. The present invention addresses such a need.

### SUMMARY OF THE INVENTION

Aspects for achieving efficient, multiple peripheral functionality in portable computing system environments are described. The aspects include a composite adapter for performing networking and data storage functionality and capable of interfacing with a computing system via a single interface port. The composite adapter includes an embedded system, a medium dependent physical layer unit, and a data storage unit. The embedded system further includes a single integrated circuit for substantially simultaneously handling and servicing the networking and data storage functionality.

With the present invention, a high degree of integration of the two functions in a single IC (integrated circuit) is achieved and utilizes a minimum number of interface ports of a host system, which makes it useful for applications that require portability. These and other advantages of the present invention will be more readily understood in conjunction with the following detailed description and accompanying figures.

### BRIEF DESCRIPTION OF THE DRAWINGS

FIG. 1 illustrates a block diagram of a preferred embodiment of the composite adapter in accordance with the present invention.

FIG. 2 illustrates the operation of the HIU of FIG. 1 in diagram form.

FIG. 3 illustrates the front end interfaces of the embedded system of FIG. 1 for both the network and the mass storage functions.

FIG. 4 illustrates main tasks of the processor of FIG. 1 in performing the functions of networking and data storage in accordance with the present invention.

FIG. 5 illustrates a diagram for the software architecture for the tasks for the case of peripheral device mode for the adapter in accordance with the present invention.

FIG. 6 illustrates a diagram for the software architecture for the tasks for the case of disconnection from the host with running as a remote file server for the adapter in accordance with the present invention.

FIG. 7 illustrates examples of the adapter of the present invention for serial host interfaces like SDIO or USB and typical network medium, like wireless (e.g. 802.11) or wired (e.g. 802.3).

FIG. 8 shows a network topology in a mixed environment with wired and wireless connections where the nodes use adapters in accordance with the present invention.

### DETAILED DESCRIPTION

The present invention relates to a composite adapter for networking and data storage functions. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention provides a composite adapter, which utilizes a single interface port of a host system for two major functions, those of networking and data storage. The composite adapter includes an embedded system implemented in an integrated circuit, which can substantially simultaneously handle and service those two applications despite their heterogeneous nature. Further, the present invention achieves a high degree of integration of the two functions in a single IC (integrated circuit) and utilizes a minimum number of interface ports of a host system, which makes it useful for applications that require portability. Additionally included in the present invention is a software architecture of an embedded multitask code running on the local processor of the embedded system and supporting the multifunction requirements.

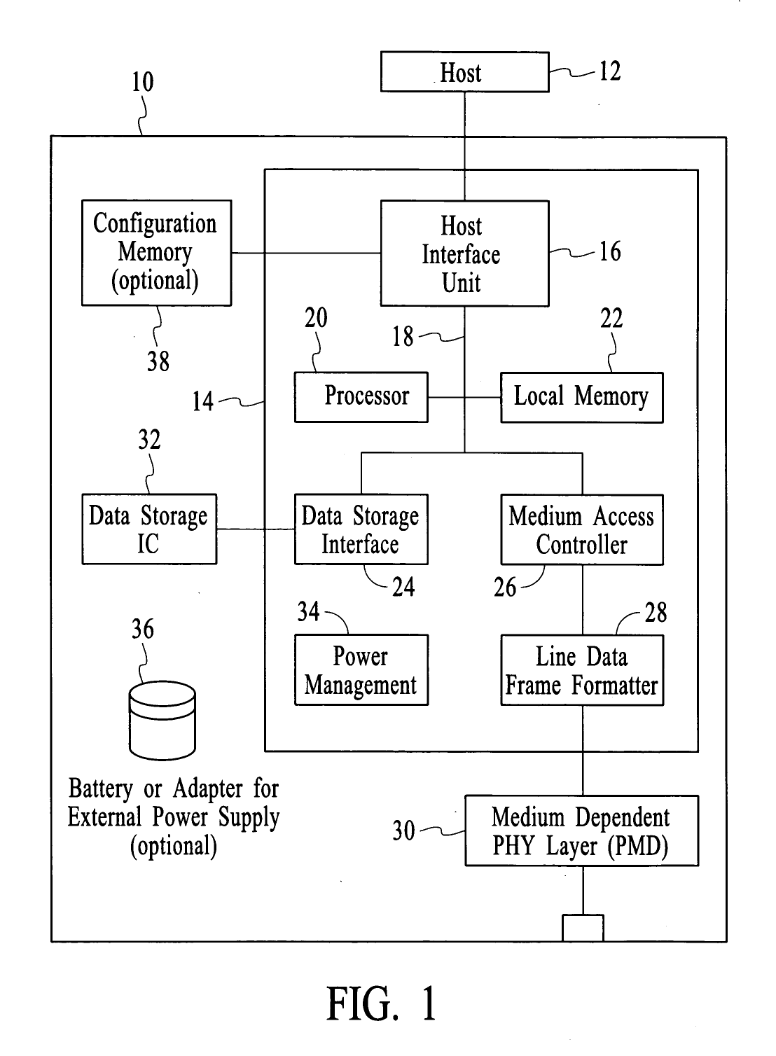

FIG. 1 illustrates a block diagram of a preferred embodiment of the composite adapter in accordance with the present invention. The adapter 10 is coupled to a host system 12 and interfaces to the host system 12 using any interface protocol that supports plug and play and multifunction/multiinterfaces. The adapter 10 includes an embedded system 14 on a single IC. As shown, a host interface unit (HIU) 16 of the embedded system 14 is the communication point for the adapter 10 with the host system 12. A local bus 18 couples the HIU 16 with a processor 20 and local memory 22. Further coupled to the local bus 18 are a data storage interface (DSI) unit 24 and a medium access controller (MAC) unit 26. A line data formatter 28 couples the medium access controller 26 with a medium-dependent PHY layer (PMD) unit 30 of the adapter 10. The data storage interface 24 couples the embedded system 14 with a data storage IC 32, such as NAND or NOR Flash. The adapter 10 further includes a power management unit 34, which is shown as integrated with the embedded system, but which may be included as a separate component. Further optionally included in the adapter 10 is a power element 36 of a battery/an adapter for an external power supply for operation in self-powered mode. The adapter 10 may include also configuration memory 38.

The HIU 16 of the adapter 10 is used to compensate for any speed differences between the interface to the host system 12 and the local bus 18 and supports temporary buffering in order for the low speed bus not to consume unnecessarily the bandwidth of the high speed one. Over this point-to-point connection, the host system 12 and the HIU 16 exchange data for the two functions of network access and data storage and for management data in a time-sharing fashion, as described further hereinbelow.

The HIU 16 is also responsible for transferring the configuration descriptors of the adaptor 10 to the host system 12 upon the request of the host system 12 during the enumeration phase and based on the plug and play specifications of the interface. The configuration descriptors can be hardwired for further system integration but optionally can be read by an external configuration memory like a non-volatile memory giving the ability for system customization, as is well understood in the art. The descriptors can activate the network access or the data storage or both these functions, such that the host system 12 will run the corresponding driver or both device drivers, which serve these functions. Upon the completion of the enumeration, the HIU 16 is ready to serve the data transfer for each of the supported functions.

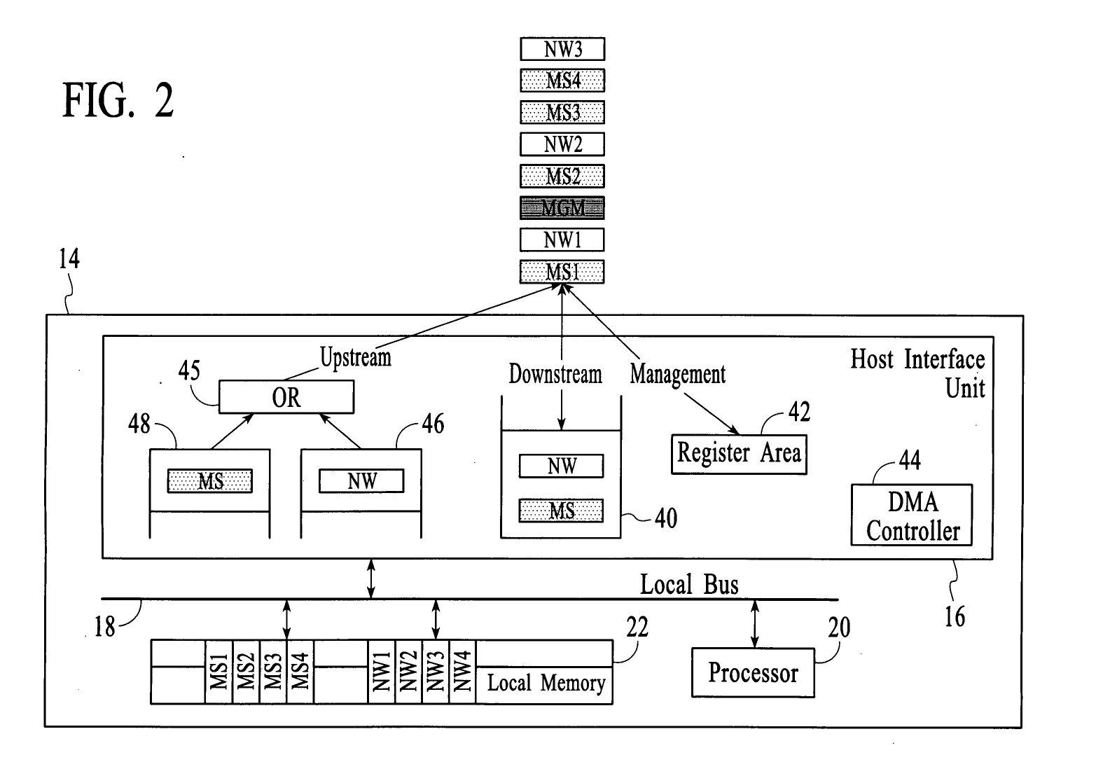

The operation of the HIU 16 is presented in diagram form in FIG. 2. In the downstream path, the same buffer or register area 40 is utilized for temporarily storing the packets of the two functions. In a preferred embodiment, any size of the single buffer area of the downstream path is allowed depending upon the application requirements and the number of packets of both functions that need to be temporarily stored in the HIU 16 before being transferred to the local memory 22 in order to compensate for the local bus latency.

As indicated in the downstream path, packets from the network driver (NWx) are time multiplexed with the packets of the mass storage (MSy) function according to the host interface specification. Management packets (MGM) are also transferred back and forth over the same link to a register area 42. For instance, for a USB interface the host 12 would send the packets of those two functions through a point-to-point connection, in a time-sharing fashion, incorporating two End Points (EPs) under the same device address (DA) but using two EP addresses (EA). Management packets are transferred over the Control EP for both interfaces. Under a conventional implementation of a USB, HIU 16 implements two End Point functions where each one would utilize its own register set and would use its own buffer space for temporary storage of the data coming from the host 12. The NWx and the MSy packets would be stored at the same physical location with a single bit used as a flag to indicate the function to which the incoming packet corresponds. A Direct Memory Access (DMA) controller 44 is included for direct memory access to the address space of the local memory 22, which is devoted for the reassembly of the data of the function indicated by the value of the flag.

In order to guarantee that a packet of any function cannot overwrite the previous stored packet of the same or the other function in the single buffer location of the HIU 16, the mechanism that each interface protocol uses for denoting that the client site is not ready to accept further data is utilized. Considering again the example of the USB interface, an assumption is made that the network function makes use of an OUT EP with DA=A and EA=a and the mass storage function of another EP with DA=A and EA=b, where a does not equal b. An output packet from the host for the Aa or Ab EP will be acknowledged with a NAK (______) by the USB host interface if the previous output packet from the host has not been transferred from the single buffer location to the local memory, irrespectively of the EP address of previous packet.

Although the previous example refers to the USB interface, the described functionality can be applied to any serial or parallel interface, which uses different addresses for pointing the buffers of the two functions. Moreover, the NAK response of the USB example, which indicates the lack of client space for accepting further data, can be replaced by a signal negotiation scheme, which is encountered in most of the Plug and Play host computer interfaces, as is well understood in the art.

In the upstream path of FIG. 2, the HIU 16 may use again a single buffer for both functions or two buffers 46, 48 for avoiding possible bottleneck. The OR logic 45 at the output of buffers 46, 48 selects which packet to be transferred to the host upon its request.

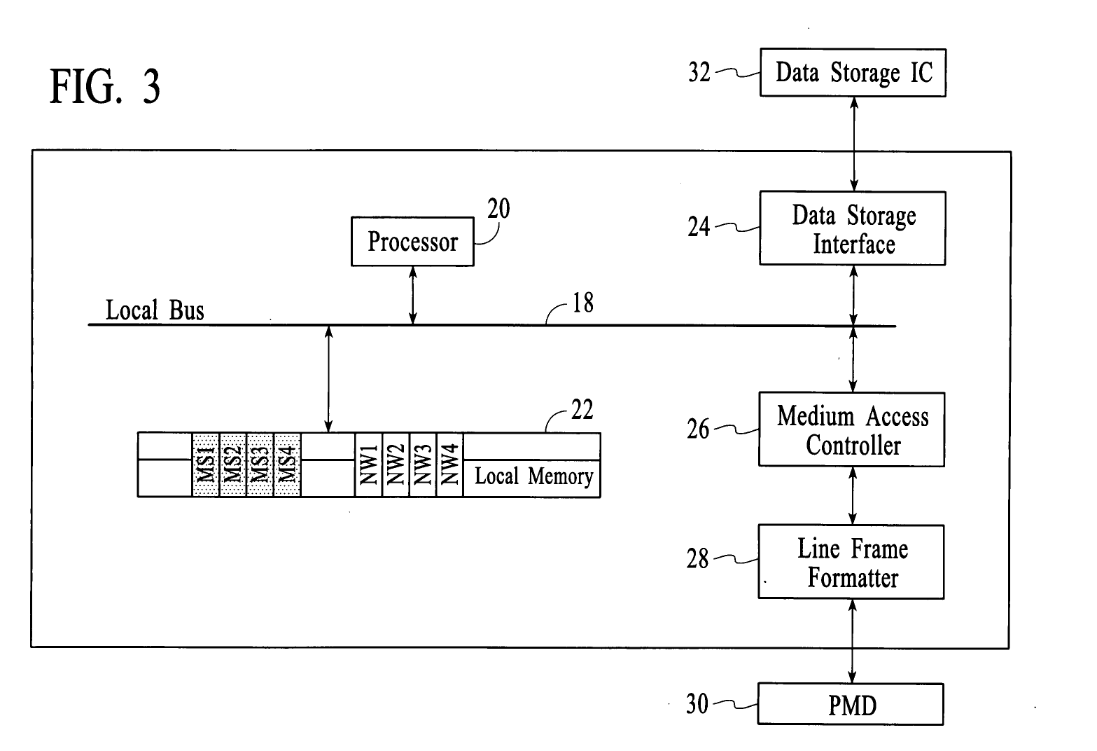

FIG. 3 illustrates the front end interfaces of the embedded system 10 for both the network and the mass storage functions. The local bus 18 is shared among the processor 20, the DSI unit 24 and the MAC unit 26. It should be appreciated that the architecture shown in this figure can be applied to any local bus system, independently of the number of levels implemented, of the partitioning of the local memory in various levels of the local bus and of the capability of the DSI and MAC to grant ownership of the bus and transfer data using direct memory access.

The DSI unit 24 is responsible for keeping the right timing during read/write access to the external data storage IC (32, FIG. 1) while complying with the electrical characteristics of the external data storage IC. Further, triggering of the DSI unit 24 to store or retrieve data to and from the Data Storage IC is done by the HIU (16, FIG. 1). The DSI unit 24 is also responsible for fetching/putting data from/to the local memory 22 if the local bus 18 supports multi-masters. The DSI 24 can drive the local bus 18, implementing a register set accessible by the other masters of the local bus 18.

The line data frame formatter 28 has to modulate the outgoing packets to the network or demodulate the incoming packets from the network, according to the protocol and medium requirements. For the purposes of this disclosure, unless otherwise indicated, the term modem or modem function is used to describe the procedure of modulation in the downstream path and demodulation in the upstream path. The modem function may be digital or analog and all operation can take place in the embedded system 14 or part of this can be implemented by the external physical medium dependent (PMD) unit (30, FIG. 1). This function may be as simple as a line coding usually encountered in wired network protocols (e.g. Manchester encoding for Ethernet) or incorporate advanced signal processing techniques like carrier modulation, spread spectrum, equalization, etc., as is well appreciated by those skilled in the art.

The MAC unit 26 of the embedded system 14 formalizes the network data provided by the host (12, FIG. 1) according to the specifications of the network protocol that is implemented by the adapter 10 for the downstream data path. Typical formalization at this level includes multiple functions, e.g., addressing, packet prioritizing and typecasting, checksum calculation for data integrity checking, packet segmentation and packet preparation by inserting the data fields generated by the aforementioned operations either as a header (MAC header) or as a packet tail. The packet then will be forwarded to the line data frame formatter 28 according to a medium access mechanism defined by the particular network protocol. Known and typical examples of such mechanism are the Carrier-Sense-Multiple Acess (CSMA) with Collision-Avoidance (CSMA/CA), as applied in 802.11 or with Collision-Detect (CSMA/CD), as applied in 802.3, token based protocols or even simpler based on dedicated, point-to-point connection with freedom to access the medium whenever data is available.

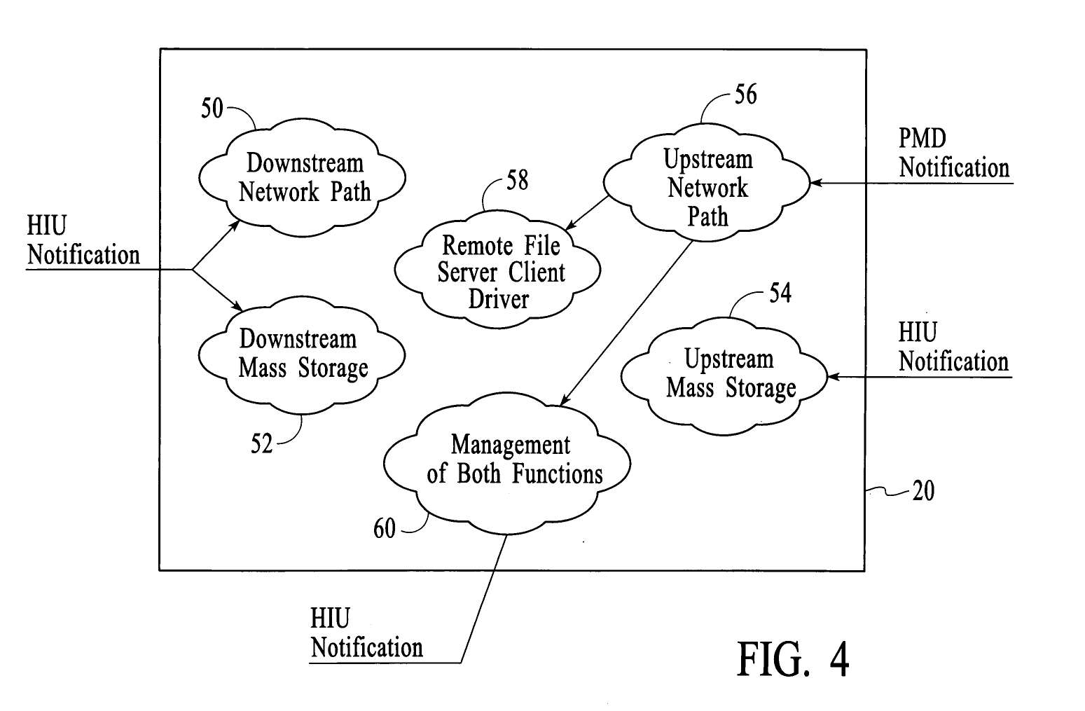

In the upstream direction, when the MAC unit 26 of the embedded system 14 receives a packet from the line data frame (de-)formatter 28, it parses the fields added by the sender MAC, and some of the main functions it performs are address checking and packet approval, receive notification signaling, packet type and priority recognition, data integrity checking and data reassembly. The MAC unit 26 itself or with the aid of the processor 20, performs further packet filtering for identifying the packets destined to the ‘remote file server client driver’ task, as described in more detail with hereinbelow with reference to FIG. 4.

In performing the functions of networking and data storage with the embedded system 14, the main tasks that are dealt with by the processor 20 are shown in the diagram of FIG. 4. These tasks include handling of the downstream network path 50, the downstream mass storage path 52, or the upstream mass storage path 54 upon notification from HIU 16. The processor 20 must further handle the upstream network path 56 and remote file server client driver 58 upon notification by the PMD 30. The functionality to manage all the forms of notifications 60 from the HIU 16 and PMD 30 is also included. Preferably, the handling of these tasks by the processor is performed according to suitable software implemented using standard techniques on a computer readable medium, such as local memory 22, in a chosen software application, as is well understood in the art. Of course, not all of the tasks need to be implemented, depending upon the device configuration as peripheral device mode or standalone device mode.

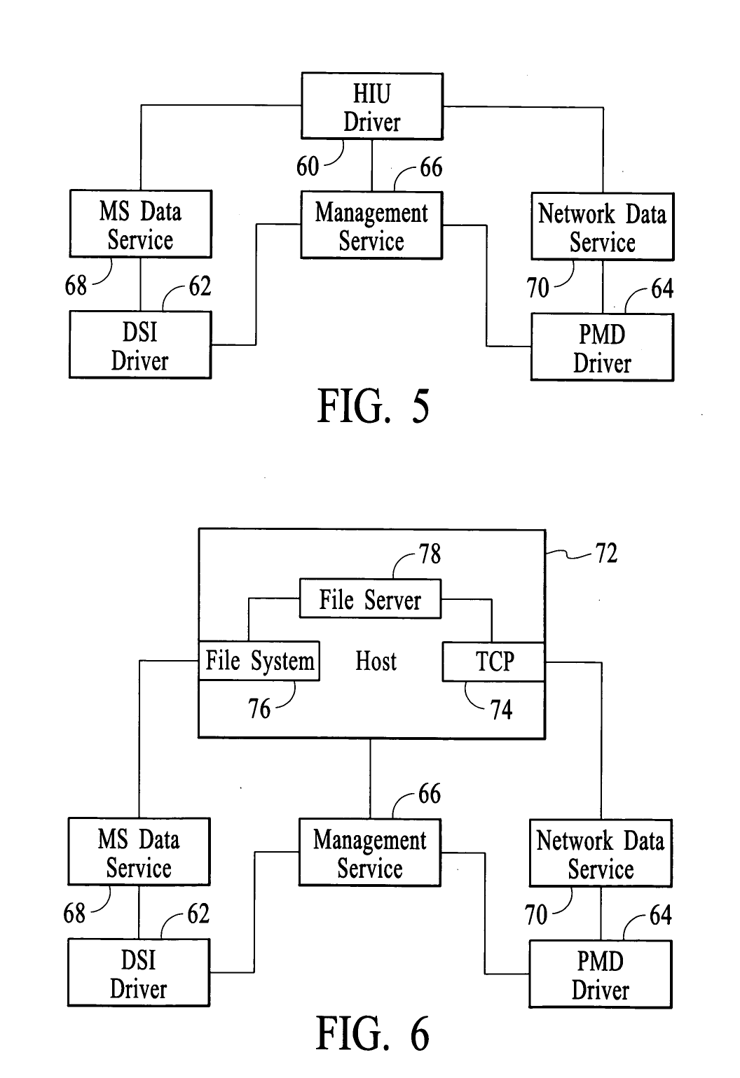

For the case of the peripheral device mode, the software architecture for the tasks is illustrated in the block diagram of FIG. 5. As shown, the major blocks are three device drivers and three services. In correspondence with each of the underlying hardware interfaces, an HIU driver 60, a DSI driver 62, and a PMD driver 64 are included. The three services each correspond to one of the services that are needed for the system implementation. Thus, a management service 66 is included and is common for the HIU driver 60, the DSI driver 62 and the PMD driver 64. A data service 68 for the DSI driver 62 is included and interacts with both the DSI driver 62 and HIU driver 60. A network data service 70 for the PMD driver 64 is included and interacts with the PMD driver 64 and the HIU driver 60.

In the case of the standalone device mode, the software architecture is more complicated due to the lack of the host system 12, as illustrated in FIG. 6. In this case, the HIU device driver is omitted and a host function 72 is implemented by the processor 20.

More particularly, the host function 72 includes a TCP stack 74, a file system 76, and a remote file server client driver 78.

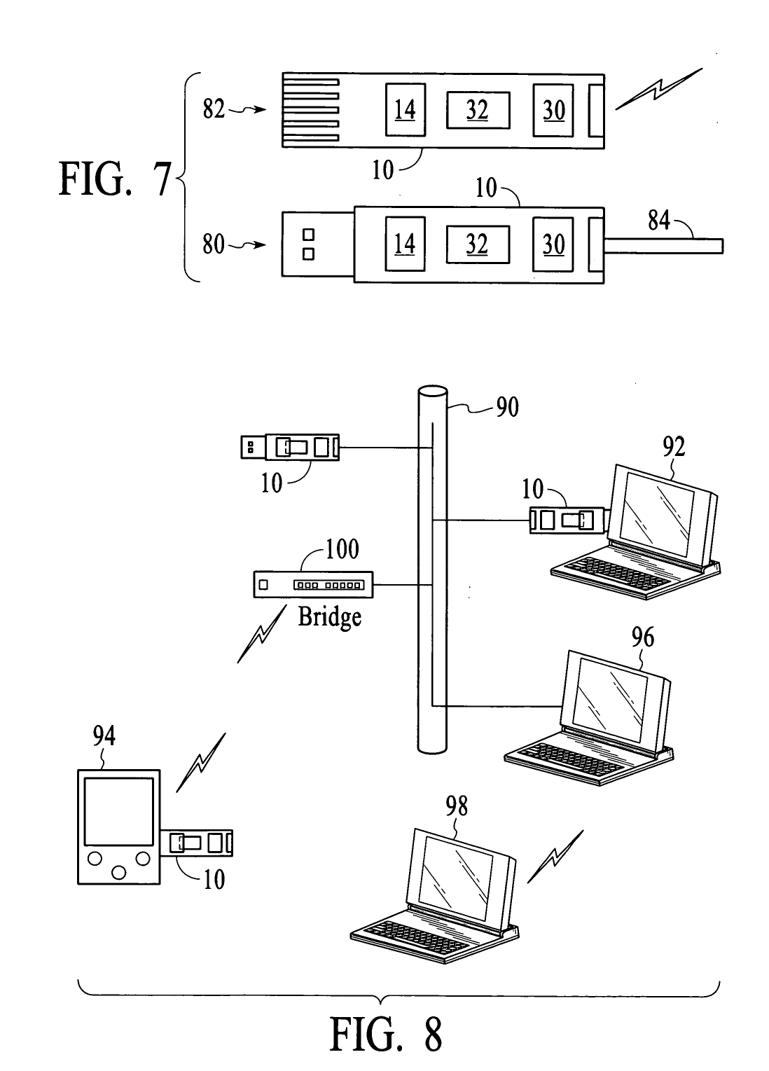

A representation of the adapter 10 in accordance with the present invention is presented in FIG. 7, which illustrates small form factor implementations utilizing interfaces, such as USB 80 and SDIO 82, as shown. Of course, other favorite PnP interfaces encountered in portable devices could also be used. Further illustrated in the example adapters of FIG. 7 are a wired connector 84 for connection to a wired network and a wireless connection 86 (e.g., a radio frequency (RF) transceiver) to provide access to a wireless network. Thus, any combination of host interface—transmission medium may be implemented, with particular emphasis to wireless protocols like 802.11 and Bluetooth that allow easy connectivity to portable systems.

FIG. 8 illustrates an example of utilization of the adapter 10 in accordance with the present invention in a heterogeneous environment with a network backbone 90. The network 90 shown includes a wired connection of a portable computer system 92 via the adapter 10, such as to provide wired network access and data storage, a wireless connection of a handheld device 94 via the adapter 10, such as to provide data storage capabilities of high capacity in a small form factor apparatus as well as simultaneous wireless network connection engaging only one port, and a wireless connection of a self-powered adapter 10, which is used autonomously as a network device running a client DHCP with a light TCP stack and a client file system application software. Further shown are other portable systems 96 and 98, as well as bridge 100, with wired and wireless connections, as would be conventionally present in a network environment.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. An apparatus for achieving efficient, multiple peripheral functionality in portable computing system environments, the apparatus comprising:
a composite adapter for performing networking and data storage functionality and capable of interfacing with a computing system via a single interface port.

2. The apparatus of claim 1 wherein the composite adapter further comprises an embedded system, a medium dependent physical layer unit, and a data storage unit.

3. The apparatus of claim 2 wherein the embedded system further comprises a single integrated circuit for substantially simultaneously handling and servicing the networking and data storage functionality.

4. The apparatus of claim 2 wherein the embedded system further comprises a host interface unit as a communication point for the composite adapter with the computing system.

5. The apparatus of claim 4 wherein the embedded system further comprises a processor, local memory, and a local bus, the local bus coupling the host interface unit with the processor and the local memory.

6. The apparatus of claim 5 wherein the embedded system further comprises a data storage interface unit and a medium access controller unit coupled to the local bus, the data storage interface unit coupling the embedded system with the data storage unit.

7. The apparatus of claim 6 wherein the embedded system further comprises a line data formatter, the line data formatter coupling the medium access controller with the medium-dependent physical layer unit.

8. The apparatus of claim 2 wherein the embedded system further comprises a power management unit.

9. An integrated communication and mass storage portable system comprising:
a host computing system;
a communication and mass storage integrated circuit coupled to the host computing system;
a power management unit for managing power for the communication and mass storage integrated circuit;
a storage device coupled to the communication and mass storage integrated circuit; and
a network medium dependent adapter for coupling the host computing system to a network.

10. The integrated communication and mass storage portable system of claim 9 wherein the network medium dependent adapter further comprises an RF (radio frequency) transceiver for wireless coupling of the host computing system with the network.

11. The integrated communication and mass storage portable system of claim 9 wherein the network medium dependent adapter further comprises magnetic components for wired coupling of the host computing system with the network.

12. The integrated communication and mass storage portable system of claim 9 wherein the storage device further comprises Flash memory.

13. The integrated communication and mass storage portable system of claim 9 wherein the communication and mass storage integrated circuit includes the power management unit.

14. The integrated communication and mass storage portable system of claim 9 further comprising an adapter, the adapter comprising the communication and mass storage integrated circuit, the power management unit, the storage device, and the network medium dependent adapter.

15. The integrated communication and mass storage portable system of claim 14 wherein the adapter further comprises an interface, the interface coupling the adapter to the host computing system via a single interface port.

16. The integrated communication and mass storage portable system of claim 14 wherein the adapter further comprises a power system for self power operation the self power operation providing operation of the adapter as a remote file server with or without connection to the host computing system.

17. The integrated communication and mass storage portable system of claim 9 wherein the host computing system further comprises a portable computing system, the portable computing system including a hand-held computing system.

18. A method for achieving efficient, multiple peripheral functionality in computing environments, the method comprising:
providing a composite adapter that performs data storage and.networking functionality for a host computing system; and
interfacing the composite adapter with the host computing system via a single interface port.

19. The method of claim 18 wherein providing the composite adapter further comprises providing a communication and mass storage integrated circuit, a power management unit, a storage device, and a network medium dependent adapter, the communication and mass storage integrated circuit substantially simultaneously handling and servicing the networking and data storage functionality.

20. The method of claim 18 further comprising providing the composite adapter as a self-powered device for self power operation that provides operation of the adapter as a remote file server with or without connection to the host computing system.
